(19) United States
(12) Patent Application Publication
(10) Pub. No.: US 2010/0332641 A1
(43) Pub. Date: Dec. 30, 2010

(54) PASSIVE DETECTION OF REBOOTING HOSTS IN A NETWORK

(76) Inventors: Kulesh Shanmugasundaram, Brooklyn, NY (US); Nasir Memon, Holmdel, NJ (US)

Correspondence Address: STRAUB & POKOTYLO, 788 Shrewsbury Avenue, TINTON FALLS, NJ, 07724, US

(21) Appl. No.: 12/268,190

(22) Filed: Nov. 10, 2008

Related U.S. Application Data
(60) Provisional application No. 60/986,920, filed on Nov. 9, 2007.

(51) Int. Cl. G06F 15/173; G06F 21/00; G06F 15/177

(52) U.S. Cl. 709/224; 726/1; 713/2

(57) ABSTRACT

Host reboots may be detected passively by tracking and analyzing host initialization events and/or by tracking and analyzing temporal skews in periodic events. Detected host reboots may then be used to determine or help determine whether or not the host has a possible malware infection.

### §0. PRIORITY CLAIM

This application claims the benefit of U.S. Provisional Patent Application Ser. No. 60/986,920 (incorporated herein by reference and referred to as “the '920 provisional”), titled “A METHOD FOR PASSIVE DETECTION OF REBOOTING HOSTS TN A NETWORK” filed on Nov. 9, 2007, and listing Kulesh SHANMUGASUNDARAM and Nasir MEMON as the inventors. The present invention is not limited to requirements of the particular embodiments described in the '920 provisional.

§1. BACKGROUND OF THE INVENTION

§1.1 Field of the Invention

The present invention concerns detecting rebooting hosts in a network. In particular, the present invention concerns identifying possible malware infections in a host by passively detecting and measuring rebooting hosts in a network.

§1.2 Background Information

Today, PCs and computer networks are vulnerable to attacks from a variety of globally-distributed sources. These sources range in size and scope from large-scale international criminal organizations to individual hackers, and their tactics continually evolve. The increasing prevalence of rootkit type attacks confirms fears that attackers are using sophisticated techniques to hide malicious programs. The focus of malware infections has typically been to hide so-called trojans, spyware, or mass circulation viruses and worms, and infect as many systems as possible. This emerging breed of sophisticated malware seeks to ensure that it goes unnoticed on the host system, and infects or re-infects other areas of the host system when needed.

These types of infections can later be used to install any malicious code to perform functions using the benefit of total concealment. For example, infected systems are often used as a SPAM platform.

Rootkits may find their way onto end user devices through known security holes in an operating system, by being downloaded with other programs, or any other common infection technique. Rootkits infect a host system by either replacing or attaching themselves to system components, thereby making their detection by the operating system extremely difficult.

Given the capability of rootkits to mask their activity, conventional scanning engines based on known bad file signatures are often completely ineffective. In other words, often, a malware infection will be totally stealth and can remain for great lengths of time without being detected.

Unfortunately, to date, there are no established mechanisms that can reliably detect the presence of such malware once a computer is infected with them. Therefore, it would be extremely useful to detect if and when a host computer is compromised (i.e., when the host computer is infected with malware).

### §1.2.1 Previous Approaches and Perceived Limitations of such Approaches

Although there are a variety of measures to prevent infection with such malware, once infected, detecting the presence of rootkits and the products they are hiding is not trivial. Essentially, a definitive solution to rootkit (based malware) detection requires an uninfected copy of the system to be available as a reference. In this setting, to circumvent the cloaking effect of the rootkit, the uninfected system has to perform a file-by-file comparison with the test system to discover the rootkit and its payload.

Aside from practical difficulties in maintaining a reference copy, systems are not typically static—legitimate changes take place quite frequently within a system. These changes make a simple reference copy file comparison approach inapplicable in many, if not most, cases. Therefore, in practice, detectors have to work within the potentially infected host system to detect malicious programs and their traces in a blind manner, while avoiding placing too much trust on observations provided by the potentially infected host system itself.

Today, most existing virus detectors operate by targeting specific rootkits. These detectors, in general, will search for hidden files, folders and processes, compare user mode information to kernel node (e.g., differences between the system registry and file system), and try to identify active kernel hooks established by unknown programs (either automatically or through advanced analysis tools which allows users to examine a host system's operations in detail). However, one deficiency of this class of detectors is that malicious software developers are aware of these techniques and are constantly developing their malware products to evade such detection methods.

### §2. SUMMARY OF THE INVENTION

Embodiments consistent with the present invention may be used to detect host reboots passively. At least some exemplary embodiments consistent with the present invention may do so by (a) storing a list of one or more host initialization events, each of the one or more host initialization events being associated with a host system, (b) receiving packet destination information derived from packets sourced from the host system, (c) comparing the received packet destination information with the list of one or more host initialization events to determine whether any matches occur, (d) incrementing the value of a count variable if a match is determined to exist, otherwise, maintaining the count variable at its current value, and (e) determining whether one or more reboots of the host occurred using the value of the count variable. Since detecting host reboots may facilitate host malware (or host change) detection, at least some embodiments consistent with the present invention may control the execution of a host malware protection policy using a value of the count variable.

At least some other exemplary embodiments consistent with the present invention may detect host reboots passively by (a) accepting information of packet flows for the host system, wherein each of the packet flows corresponds to one or more events, and wherein a plurality of packet flows corresponding to a given one of the one or more events exhibit periodicity, (b) determining, for each of the one or more events, whether or not the event exhibits a phase change using the corresponding plurality of packet flows, and (c) determining whether one or more reboots of the host occurred using the determination of whether or not the event exhibits a phase change. Since detecting host reboots may facilitate host malware (or host change) detection, at least some embodiments consistent with the present invention may control the execution of a host malware protection policy using the determination of whether or not the event exhibits a phase change.

### §3. BRIEF DESCRIPTION OF THE DRAWINGS

FIG. 1 is an exemplary environment illustrating components of an exemplary system consistent with the present invention.

FIG. 2 is an exemplary environment illustrating operations, as well as information used or generated, in an exemplary system for determining host reboots using host initialization events consistent with the present invention.

FIG. 3 is a flow diagram of an exemplary method that may be used to monitor and detect host system reboots within a network using host initialization events, for purposes of facilitating malware detection, in a manner consistent with the present invention.

FIG. 4 is an exemplary environment illustrating operations, as well as information used or generated, in an exemplary system for determining host reboots using temporal skews in periodic events consistent with the present invention.

FIG. 5 is an illustration depicting sliding windows used for determining periodic events that occur within a network by analyzing flow records/packets.

FIG. 6 is a flow diagram of an exemplary method that may be used to monitor and detect host system reboots within a network using temporal skews in periodic events, for purposes of facilitating malware detection, in a manner consistent with the present invention.

FIG. 7 is a block diagram of an exemplary apparatus that may perform various operations and methods, and store various information generated and/or used by such operations and methods, in a manner consistent with the present invention.

### §4. DETAILED DESCRIPTION

The present invention may involve novel methods, apparatus, message formats, and/or data structures to facilitate the detection of possible malware infections in a host system by passively detecting and measuring rebooting hosts in a network. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

### §4.1 General Environment and Method for Host Reboot Detection

Network-based techniques to identify host systems (e.g., computers) that are potentially infected with (e.g., persistent) malware are described. Such techniques should even allow the detection of malware which cannot be reliably detected using conventional host-based detection techniques. Embodiments consistent with the present invention may observe the behavior of a host system at a network level. Specifically, passive detection of rebooting hosts in a network is a useful symptom to identify infected or faulty hosts. Such embodiments may be viewed as an initial step in malware infection detection, which may be followed by more targeted host-based detection techniques to determine the type and extent of infection.

Embodiments consistent with the present invention may exploit the fact that when a malware infects a host, the host operating system can often become unstable and unresponsive. In either case the user of the host or the operating system itself may restart the host in an attempt to fix the problem. Therefore, if an observer (machine) can accurately determine when a host is rebooted or how frequently, then the observer can evaluate the health of the host.

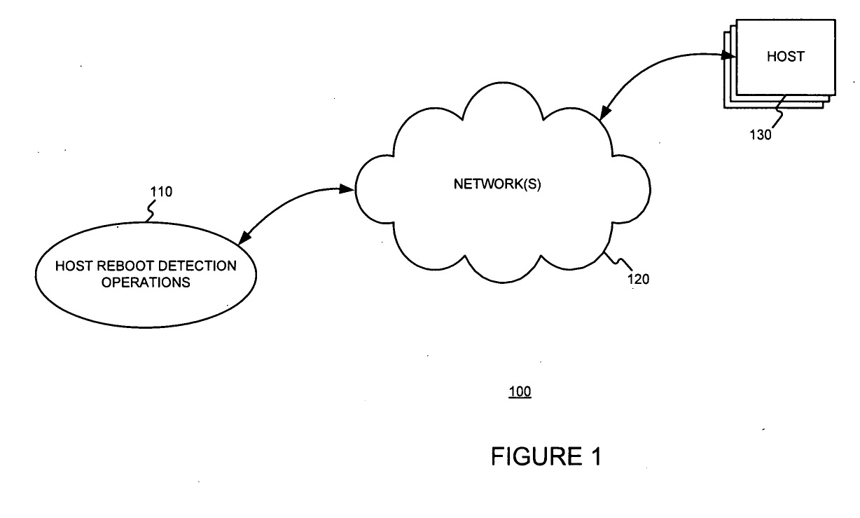

FIG. 1 is an exemplary environment illustrating components of an exemplary system consistent with the present invention. Specifically, the components may include host reboot detection operations 110 and a number of hosts 130 communicating through one or more network(s) 120. A host 130 may be a potentially infected system connected to network(s) 120. The host reboot detection operations 110 may passively monitor network traffic multiple hops away from the hosts 130 within the network(s) 120, thereby allowing the host reboot detection operations to detect a rebooted host 130 within the network(s) 120.

A preferred method of reboot detection for a large networked environment would be passive and should be able to detect the event from multiple hops away from the host itself. There are two major approaches that can be taken to detect reboots from the network—(1) detecting host initialization events, and (2) detecting temporal skew in periodic events. Each approach is described below.

In the first approach, the reason behind using host initialization events for detecting reboot is that often a flurry of initializations takes place in a host upon reboot. This occurs because, for example, when a host reboots it needs an IP address so it contacts a DHCP server to request one. Furthermore, when a host reboots, an array of applications starts running, such as Instant Messengers, VoIP clients, email clients, software update, security applications, etc. These applications make a connection over the network to their corresponding servers to sign-up a user, check for updates and various other reasons.

The host initialization events can be grouped into the following categories—(1) operating system induced events and (2) user induced indicators. Operating system induced events may include, for example, protocol-based events (a link level property) (such as, for example, patterns in ARP/DHCP requests, patterns in TCP SIN field, etc.), and destination-based events (such as, for example, connection to OS update services, connection to time synchronization services, connection to application update services, etc.). User induced indicators may include, for example, OS update services, connections to IM/VoIP for login requests, email/browser activity, etc.

A set of host initialization events that occurs within a predefined time window indicates, with high probability, that a reboot has occurred. This fact may be employed to ultimately determine a possible malware infected host within a network.

In the second approach, once a host is up and running an observer (machine) can notice periodic events on the network. These events occur because applications often update their status and these updates are carried out periodically. For example, an email client may check email every minute, a web browser may refresh a page every five minutes, or an application may check for updates every 24 hours. However, after a reboot, these events will be temporally skewed. For example, an application that performed an action every hour on the hour may now perform the same task every hour but 5 minutes past the hour. Such temporal skews can indicate that a host has rebooted and ultimately lead to a determination of a possible malware infection on the host.

Besides the events that were described above, a third parameter may be used to improve the detection accuracy of reboots. From the perspective of an observer (machine), a host is considered to be under “radio silence” when it has not shown any network activity during a period of time. A host that rebooted will generally have a shorter period of radio silence than a host that wakes up from sleep or that is powered up. This different radio silence can be used to separate the reboots from sleep awakes and power ups.

### §4.2 Host Reboot Determination and Measurements

### §4.2.1 General Method and Environment for Host Reboot Determination Using Host Initialization Events

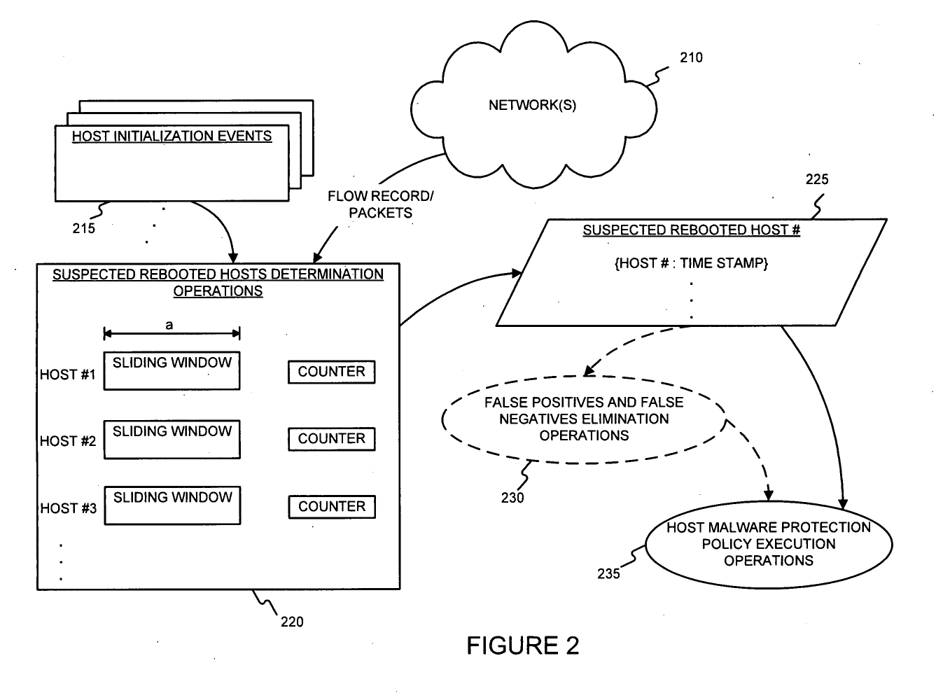

FIG. 2 is an exemplary environment illustrating operations, as well as information used or generated, in an exemplary system for determining host reboots using host initialization events consistent with the present invention. Specifically, the exemplary environment may include a number of host initialization event information 215, suspected rebooted hosts determination operations section 220, one or more network(s) 210 providing network traffic information (e.g., flow records/packets) from hosts (not depicted) within the network(s) 210, determined suspected rebooted host(s) information 225, false positives and false negatives elimination operations 230, and host malware protection policy execution operations 235.

As discussed earlier, host initialization events 215 occur whenever a host is powered up or rebooted. Often these events occur within a small time window which usually indicates that the host has been powered up/rebooted. To detect reboots using host initialization events 215 (“HIEs”), the suspected rebooted hosts determination operations 220 may first obtain a list of HIE information 215. A simple HIE list 215 takes the form of {Destination IP Address, Destination Port} entries. This description notes that a powered up or rebooting host will contact the destination IP address at destination port as part of the process.

Though this simple list itself may be useful, the list alone has some shortcomings with respect to time and geography. More specifically, the IP addresses of hosts that provide the initialization services often change over time and based on geographic location. A more robust list can be obtained by transforming the IP-based HIE list 215 into a domain or autonomous system (AS) owner-based list. For example, instead of observing the {Destination IP Address, Destination Port} of flows, it may he useful to observe the {Destination AS-Owner} (such as Apple Inc., Microsoft, Inc.) or {Destination Domain} (such as *.apple.com or *.microsoft.com) and port number. Likewise, destination port can be transformed to a name or group of application, such as Antiviral Software, web server request for example. This type of transformation to a higher-level representation is very useful to reliably detect reboot because it makes detection robust to changes in the underlying network. In addition, this type of transformation keeps the HIE list 215 short compared to an IP-based list. In this way, instead of comparing flow records/packets to thousands of IP addresses, it may suffice to compare each transformed event to on the order of a dozen names or domains.

The suspected reboot host determination operations 220 described below can work with both transformed lists, as well as IP-based lists. Indeed, sometimes it is efficient to convert an AS or domain-based HIE list to an IP-based list before detection. Input to the suspected rebooted host determination operations 220 may include one or more HIE list(s) 215 and a stream of packet and/or flow records with additional information. Based on the type of HIE list used, the additional information could vary. For instance, an IP-based HIE list might require destination IP address and destination port, whereas a domain-based HIE list might require domain names and destination ports. For simplicity, in the exemplary embodiments described below, a flow record will be considered to be the required information regardless of the type of HIE list.

After the suspected rebooted host determination operations 220 obtain host initialization events 215 and the stream of flow records and/or packets, it may determine and output suspected rebooted hosts 225 within a network identified. Each entry of 225 might include, for example, a host number and time/date stamp. The suspected rebooted host determination operations 220 might include a predefined initialization window as a time window within which host initialization events 215 occur during power up or reboot. Suppose, for example, that the length of an initialization window is (a) time units. As flow records steam from the network(s) 210 into the suspected rebooted host determination operations 220, a sliding window of length (a) might be maintained for every host on a network. In such a window, the time difference between the first and the last event would be less than or equal to (a) time units.

Each destination IP (or the corresponding transformation) and port number (or the corresponding transformation) of each incoming flow into a window is compared to the HIE list 215. Each time a match is found, a counter is incremented for the window of the host. When a flow leaves the window, if the flow contributed to the count, then the counter is decremented accordingly. The counter is tested (e.g., periodically) to see whether it has reached a predefined threshold. If the suspected rebooted host determination operations 220 find the counter to have reached the threshold, they conclude that the host has rebooted. The time of reboot might be declared as the time of the first event in the window when the threshold is reached. Hence, the 220 operations may output a list of suspected rebooted hosts 225 identified by, for instance, a host number and a time/date stamp of when the suspected reboot occurred.

The list of suspected rebooted hosts 225 may then be obtained by the host malware protection policy execution operations 235 which may take malware protection actions (e.g., in accordance with a host malware protection policy). For example, such policies might include one or more of notifying a user of a host (via the host or via some other device) of potential malware on the host, notifying an administrator responsible for the host of potential malware on the host, notifying peers of the host of potential malware on the host, quarantining the host, performing special processing on any data (e.g., executables) received from the host, etc.

In another scenario, the suspected rebooted hosts 225 may be first checked by the false positive and false negatives elimination operations 230 before the host malware protection policy execution operations perform any actions on the suspected hosts 225. The operations 230 may perform various actions to prevent false positives and false negatives of rebooted hosts occurring. For example, the operations 230 might adjust the threshold in the operations 220 properly. As another example, the operations 230 might use radio silence. The use of a threshold in the suspected rebooted host determination operations 220 may help reduce the number of false positives (where a host is declared rebooting when it is not) due to HIE events occurring during normal operations. The higher the threshold, the lower the false positives. On the other hand, if the threshold is increased too much, this may result in false negatives (as not every host may have enough HIEs to surpass the threshold). A description of how using the radio silence periods can help reduce both false positives and false negatives is described later.

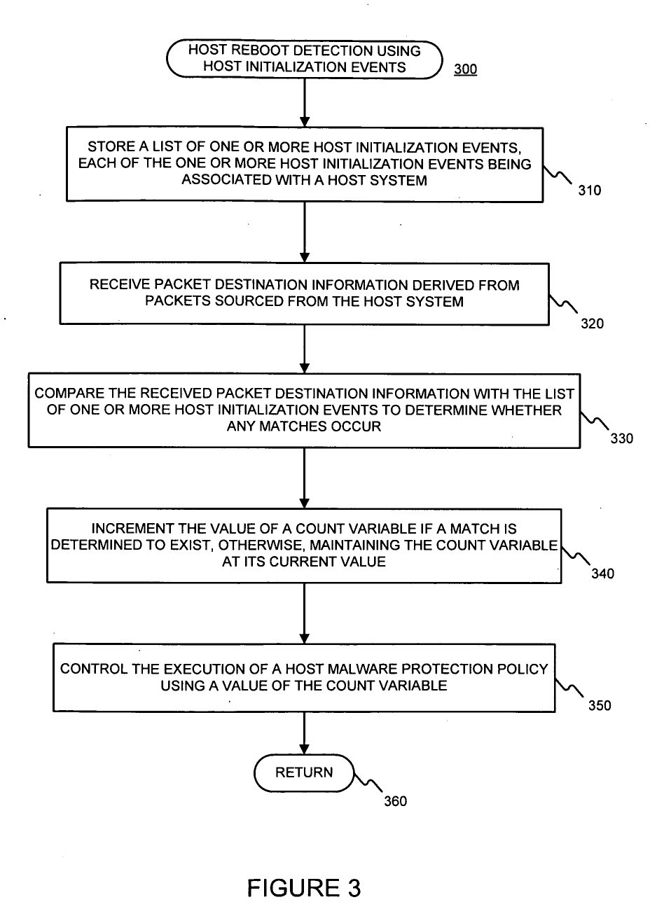

FIG. 3 is a flow diagram of an exemplary method 300 that may be used to monitor and detect host system reboots within a network using host initialization events, for purposes of facilitating malware detection, in a manner consistent with the present invention. Specifically, the method 300 may store a list of one or more host initialization events, wherein each of the one or more host initialization events is associated with a host system. (Block 310) The method 300 may receive packet destination information derived from packets sourced from the host system. (Block 320) Subsequently, the method 300 may compare the received packet destination information with the list of one or more host initialization events to determine whether any matches occur. (Block 330) Thereafter, the method 300 may increment the value of a count variable if a match is determined to exist (otherwise, it 300 may maintain the count variable at its current value). (Block 340) Finally, the method 300 may control the execution of a host malware protection policy using a value of the count variable (Block 350) before the method 300 is left (Node 360).

### §4.2.2 General Method and Environment for Host Reboot Determination Using Temporal Skews in Periodic Events

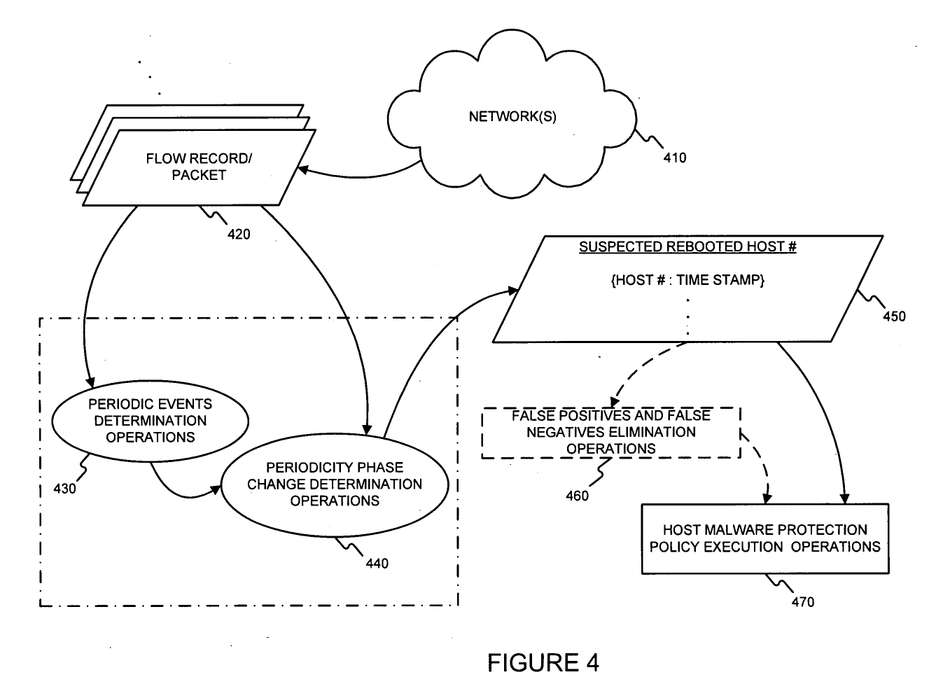

FIG. 4 is an exemplary environment illustrating operations, as well as information used or generated, in an exemplary system for determining host reboots using temporal skews in periodic events consistent with the present invention. Specifically, the exemplary environment may include a number of flow records/packets 420, periodic event determination operations 430, periodicity phase change determination operations 440, one or more network(s) 410 providing network traffic information (i.e., flow records/packets 420) from hosts (not depicted) within the network(s) 410, determined suspected rebooted host(s) information 450, false positives and false negatives elimination operations 460, and host malware protection policy execution operations 470.

Computers are very good at performing repetitive tasks. During normal operations of a host, there can be a lot of network observable events that occur periodically. For example, a mail client may connect to a mail server to check emails every five minutes or, a news reader may connect to a set of web servers to refresh its content every hour. Likewise many events occur every X (e.g., 5) minutes, others every Y hours, and some others every Z (e.g., 1) days. When a host; is turned off and turned back on or when a host is rebooted, these events will skew temporally. For example, suppose a news reader in a host is refreshing its content every hour on the hour. Now suppose that the host is rebooted and the news reader is started again. The reader will refresh its content every hour but it will no longer refresh it on the hour since the reboot has interrupted its cycle. More precisely, suppose the periodicity of an event is f and the reboot time of a host is δ. Further suppose the time (from an epoch) at observation i is tᵢ. Prior to reboot expected occurrence of the periodic event is (tᵢ+f) whereas after a reboot expected occurrence is at (tᵢ+(f+δ)). The skew in the periodic event δ occurs due to the reboot. If it can be detected that a skew has occurred in a set of periodic events, then it may be certain there was either a power cycle or a reboot. The processes of the periodic event determination operations 430 and the periodicity phase change determination operations 440 for determining any suspected rebooted hosts 450 is described below.

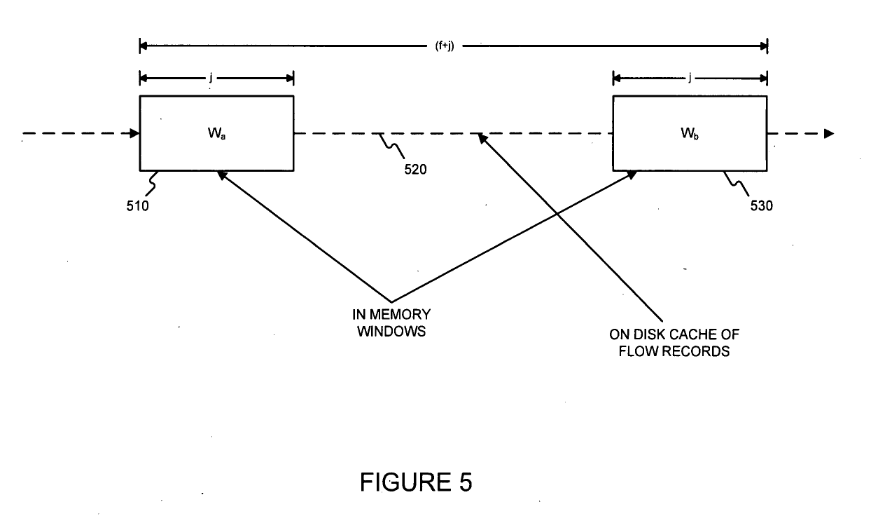

Input to the periodic event determination operations 430 is a stream of flow records/packets with information describing an event. For example, a simple flow record/packet would have source and destination IP addresses and port numbers along with a time/date stamp on when the flow started. The periodic event determination operations 430 determines periodic events that occur by processing the flow records/packets obtained from the network(s) 410. Specifically, FIG. 5 is an exemplary illustration of how the operations 430 may use a sliding window to determine periodic events that occur within a network 410 by analyzing flow records/packets 420. An event with periodicity f has observable periodicity of (f+j), where j is the jitter introduced by various host and network conditions. Therefore, the periodic events determination operations 430 may maintain two sliding windows Wₐ 510 and W_{b} 530 of length j time units that are (f−j) time units apart on the flow data. Suppose the first sliding window is Wₐ 510 and the second window is W_{b} 530. The operations 430 may maintain both the windows such that: (1) the distance between the earliest and the latest event in the window is less than or equal to j; and (2) the distance between the end of window Wₐ 510 and beginning of window W_{b} 530 is (f−j). In other words, the distance between the earliest event in window Wₐ 510 and the latest event in window W_{b} 530 should be equal to the observable periodicity (f+j).

As the periodic event determination operations 430 receive streams they may simply insert a new event into window W_{b} and remove appropriate events to maintain its width j, while inserting the event f time units prior into Wₐ and removing appropriate events to maintain its width at j. Each event that is inserted into a window is compared with the contents of the other window. When a match is found, it may be marked as a periodic event with frequency f and the time at which this event occurred (in relation to an epoch) may also he stored. Otherwise, the periodic event determination operations 430 may slide the windows over by inserting/removing events and repeating the process.

As the periodic event determination operations 430 pick up periodic events, the periodicity phase change determination operations 440 compare the periodicity of identical events to determine whether there is a noticeable skew. The periodicity phase change determination operations 440 may do so by obtaining information on periodic events from the operations 430, obtaining flow record/packet information 420 and analyzing such information. The periodicity phase change determination operations 440 may simply compare the times (t₍ᵢ₊₁₎) at which events occur to their previous occurrences (tᵢ) and indicate a temporal skew if and only if ((t₍ᵢ₊₁₎−ti)≧(f+j+δ)). When the number of events with temporal skews exceeds a threshold, the periodicity phase change determination operations 440 indicate that a host has rebooted.

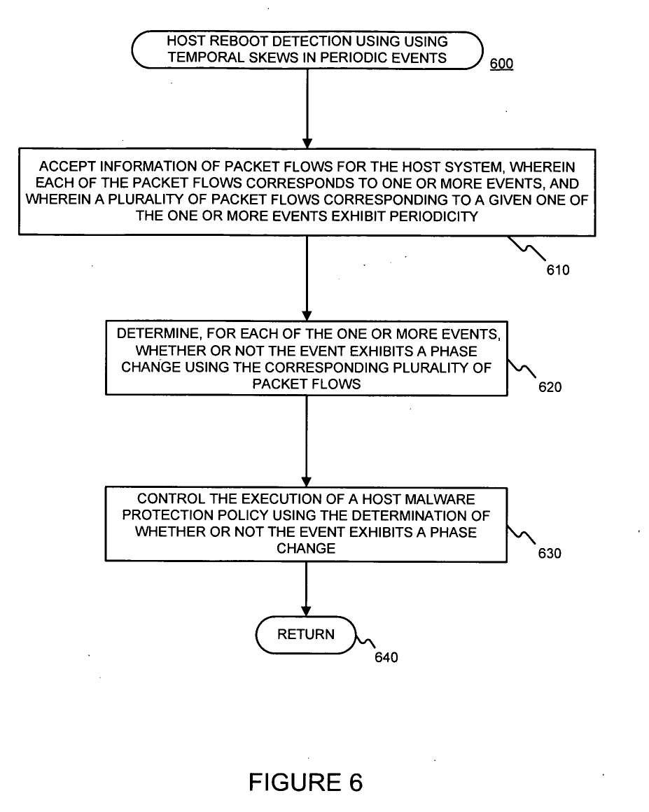

FIG. 6 is a flow diagram of an exemplary method 600 that may be used to monitor and detect host system reboots within a network using temporal skews in periodic events, for purposes of facilitating malware detection, in a manner consistent with the present invention. Specifically, the method 600 may accept information of packet flows for the host system, wherein each of the packet flows corresponds to one or more events, and wherein a plurality of packet flows corresponding to a given one of the one or more events exhibit periodicity. (Block 610) Subsequently, the method 600 may determine, for each of the one or more events, whether or not the event exhibits a phase change using the corresponding plurality of packet flows. (Block 620) Finally, the method 600 may control the execution of a host malware protection policy using the determination of whether or not the event exhibits a phase change (Block 630) and is then left (Node 640).

### §4.3 Exemplary Apparatus

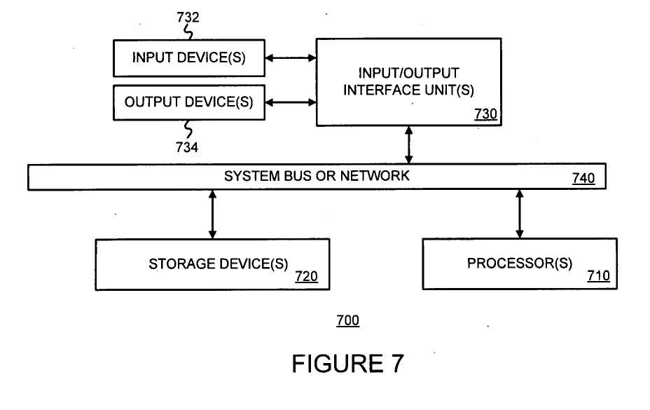

FIG. 7 is block diagram of a machine 700 that may perform one or more of the operations and methods described above, and/or store information used and/or generated by such operations and methods. The machine 700 basically includes one or more processors 710, one or more input/output interface units 730, one or more storage devices 720, and one or more system buses and/or networks 740 for facilitating the communication of information among the coupled elements. One or more input devices 732 and one or ore output devices 734 may be coupled with the one or more input/output interfaces 730. The one or more processors 710 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 720 and/or may be received from an external source via one or more input interface units 730. Thus, various acts and methods described above may be implemented as processor executed software modules, stored on a tangible medium.

In one embodiment, the machine 700 may be one or more conventional personal computers, servers, or routers. In this case, the processing units 710 may be one or more microprocessors. The bus 740 may include a system bus. The storage devices 720 may include system memory, such as read only memory (ROM) and/or random access memory (RAM). The storage devices 720 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 732, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 710 through an appropriate interface 730 coupled to the system bus 740. The output devices 734 may include a monitor or other type of display device, which may also be connected to the system bus 740 via an appropriate interface. In addition to (or instead of) the monitor, the personal computer may include other (peripheral) output devices (not shown), such as speakers and printers for example.

### §4.4 Refinements and Extensions

As discussed earlier, HIEs and temporal skews can also be observed when a host is powered on. In order to distinguish between a host being powered on and a host being rebooted, “radio silence” may be used as an effective tool.

Regarding false positives, the host reboot detection schemes described above may lead to false positives for at least two reasons. First, when many HIEs occur during the normal operation of a host, this may cause false positives. For example, a user might trigger an automated application updater (such as, AppFresh), which in turn may trigger applications to check for updates. As another example, users may login and out of a host from time to time. Second, when a host that is just turned on or woken up from sleep, it will exhibit identical events as would occur during a reboot, which may also lead to false positives. It would therefore be useful if the methods and operations described above could distinguish host reboots from sleeping hosts woken and hosts merely powered on.

In order to reduce these false positives, in at least some embodiments consistent with the present invention, the host reboot detection operations and methods described above can be further enhanced to look for a radio silence period before the very first reboot event. In this context, “radio silence” means that a host has no network activity during a time period. Therefore, the host reboot detection operations and methods can be improved such that after a window of reboot is identified, a preceding period of time is checked to determine if there is a period of network activity and then radio silence until the first reboot-related event. If so, then the host reboot detection operations and methods may declare that the host has rebooted at around the same time that the first network activity beyond radio silence occurred. This is especially useful to distinguish between host reboots and hosts just powered on. More specifically, a rebooted host usually will have a shorter radio silence period than a host woken up from sleep (or a host just powered on) because a reboot, by definition, means the host was ¢on.”

Regarding false negatives, the host reboot detection methods and operations described above do not detect and identify reboots when there are not enough events to flag them as reboots. For example, some UNIX machines may run with no additional applications that start up during boot operation, in which case the proposed methods might not work as well. However, such reboots can be detected with analysis of their ARP/DHCP requests or flurry of NetBIOS queries on Windows machines.

Regarding detecting infection, the host reboot detection methods and operations described above track how often and when a host reboots. If and when a host reboots too often or during odd hours, it is flagged symptomatic of an infection. “Too often” and “odd hours” can be quantified in relation to other similar hosts in a network. For example, a comparison of number of reboots to hosts in the same subnet may be done. Alternatively, or in addition, a comparison of network activity on similar hosts may be performed to see whether they were rebooted during the same time period.

The following discussion concerns the use of adaptive HIE lists. Specifically, as discussed in §4.2.1, an HIE list may be composed of IP addresses, domain names, or AS names or numbers with other relevant information to describe an event. As the HIE list becomes more abstract (from IP to domain to AS Number to AS Owner name), it becomes more robust to changes in IP addresses (e.g., changes over time and changes based on geographic location). A common HIE list can therefore be used to bootstrap the detection process. The HIE list can then evolve such that it captures the nuances of hosts in the deployed environment. For example, in an enterprise network, hosts may be configured to connect to a set of custom applications or services within their network, such as LDAP, Kerberose, etc. Reboot detection can bootstrap with a general HIE list and temporal skews in periodic events. Once a reboot is detected on a host, the method may simply store the contents of the last initialization window. Once the algorithm has accumulated sufficient initialization windows, it compares the contents of all the windows and augments the current HIE list with those HIEs found to be common among the majority of windows.

Referring back to periodic event determination operations 430 and periodicity phase change determination operations 440 of FIG. 4, embodiments consistent with the present invention may identify periodic events given in a data stream of event occurrences which is in the form of (eᵢ, tᵢ) for eᵢ ε {E₁, E₂, . . . , Eₙ} and tᵢ is the timestamp. An example of such data stream is given below where the time stamps are in milliseconds passed since a specific epoch:
. . . (E₃, 1207859438125) (E₁, 1207859438245) (E₈, 1207859439393) (E₁, 1207859439527) . . .
   It is assumed that the stream elements are in order with respect to timestamp values, which is the case for most of the natural streams, since the events are usually reported as they occur.

Suppose the event Eₖ occurs periodically with period T. The timestamps of successive Eₖ occurrences as:
. . . , (n−1)T+d, nT+d, (n+1)T+d, (n+2)T+d, . . .
   where n is some positive integer. Therefore, modulo T of these timestamps will be all d. The modulo T of a number is referred to as the T-phase value of that number. On the other hand, all the other events which are not periodic with period T have timestamps whose T-phase values are equal to one of the integers in interval [0, T−1] with some probability.

The basic idea of the method is to detect this repetitive occurrences of d. The method maintains an array M^{T} of length T, where each element Mᵢ^{T} is the number of observed timestamps whose T-phase values are equal to i. If there was a periodic event Eₖ in the stream with period T, T-phase values of all the Eₖ occurrence timestamps would be the same, say equal to d. Hence, Δ time units later M_{d}^{T} would be at least

$$⌊ \frac{Δ}{T} ⌋ .$$

Moreover, with high probability we have:

$${M}_{d}^{T} > \frac{Δ}{T} + \frac{N}{T} - δ \qquad ( 1 )$$

where N is the number of elements observed so far in the stream. The term N/T comes from the assumption that roughly 1/T of the T-phase values of all other non-periodic event occurrences are equal to d and the term δ accounts for the possible inaccuracies of the previous assumption and the noise in the stream. In fact probability distribution of T-phase values depends on the inter-arrival time of the corresponding event occurrences but it may be considered to be uniform distribution for simplicity and the possible non-uniformity by the term δ in Equation (1) may be dealt with.

While maintaining the array M^{T}, after Δ time units the method creates a set C of candidate T-phase values where

$$C = \{ i : {M}_{i}^{T} > \frac{Δ}{T} + \frac{N}{T} - δ \} .$$

After constructing the set C, all events eⱼ occurring at time tⱼ, for tⱼ mod T ε C are considered as possible candidates of periodic events with period T. The methods tracks such events in the list L. Since, periodic events with period T will make into list L over and over again, the number of occurrences in L of an event increases the confidence of the event being periodic with period T. After maintaining the list L for a certain amount of time Θ, the method outputs the events which have made into list L more than certain amount of time as the periodic events. A very simple pseudo-code of the method is given below.

Method: Find_Periodic_Events(S, T, Δ)

1: for i = 0 to T - 1 do
2: Mᵢ^{T} ← 0
3: end for
4: Candidates ← null
5: for all Sₙ in Stream S do
6: β ← timestamp(Sₙ) mod T
7: M_{β}^{T} ← M_{β}^{T} + 1
8: if Δ time units passed and C is not constructed then
9: Construct C, where
$C = \{ i : {M}_{i}^{T} > \frac{Δ}{T} + \frac{N}{T} - δ \} {∀}_{i} = 0 , 1 , 2 , … T - 1$
10: end if
11: if C is constructed and β ∈ C then
12: insert eventId(Sₙ) into L
13: end if
14: end for

The method described above outputs the events which may be periodic with period T with high probability. However, the period T is often unknown for most of the applications. In that case, multiple instances of the method can be executed in parallel for all possible T values, in order to detect periodic events with any possible period value.

In at least some embodiments consistent with the present invention, a separate instance of the foregoing method is not run for each event. Instead, all events are observed at once for a certain time. This means that only one array of T-Phase counts is maintained, not a separate one array for each event. After certain time, the T-phase values which occurred more the expected value are determined. Now it is known that at least one of the events is periodic with period T, but this event is (or these events are) not identified. To identify the event(s), more packets (or time-stamped events) are observed. It may be assumed that periodic events with period T will soon occur with the same T-phase value. During the second observation, the periodic events are identified as the events whose T-phase values match values previously defined to be more than the expected count. It may be necessary to observe multiple T-phase occurrences of an event to increase the level of confidence.

### §4.5 Conclusions

As can be appreciated from the foregoing, embodiments consistent with the present invention may advantageously detect or help detect malware infection of a host. Such embodiments may avoid problems with host-based malware detection.

What is claimed is:

1. A computer-implemented method for detecting host reboots passively, the computer-implemented method comprising:
a) storing a list of one or more host initialization events, each of the one or more host initialization events being associated with a host system;
b) receiving packet destination information derived from packets sourced from the host system;
c) comparing the received packet destination information with the list of one or more host initialization events to determine whether any matches occur;
d) incrementing the value of a count variable if a match is determined to exist, otherwise, maintaining the count variable at its current value; and
e) determining whether one or more reboots of the host occurred using the value of the count variable.

2. The computer-implemented method of claim 1 further comprising:
f) controlling the execution of a host malware protection policy using a value of the count variable.

3. The computer-implemented method of claim 1 wherein the list of one or more host initialization events is associated with a set of one or more host systems.

4. The computer-implemented method of claim 1 wherein in the list of one or more host initialization events, each host initialization event includes a {destination IP address, destination port} pair,
wherein the packet destination information received includes destination IP address and destination port information, and
wherein the act of comparing the received packet destination information with the list of one or ore host initialization events to determine whether any matches occur includes comparing a destination IP address and a destination port of the received packet destination information with that of the one or more host initialization events.

5. The computer-implemented method of claim 1 wherein in the list of one or more host initialization events, each host initialization event includes a destination autonomous system identifier,
wherein the packet destination information received includes a destination autonomous system identifier information, and
wherein the act of comparing the received packet destination information with the list of one or more host initialization events to determine whether any matches occur includes comparing a destination autonomous system identifier of the received packet destination information with that of the one or more host initialization events.

6. The computer-implemented method of claim 1 wherein in the list of one or more host initialization events, each host initialization event includes a destination domain identifier,
wherein the packet destination information received includes destination domain identifier information, and
wherein the act of comparing the received packet destination information with the list of one or more host initialization events to determine whether any matches occur includes comparing a destination domain identifier of the received packet destination information with that of the one or more host initialization events.

7. The computer-implemented method of claim 2 wherein the act of controlling the execution of a host malware protection policy using a value of the count variable includes
1) comparing the value of the count variable with a predetermined threshold value, and
2) executing the host malware protection policy if the value of the count variable exceeds the predetermined threshold value, otherwise, not executing the host malware protection policy.

8. The computer-implemented method of claim 2, further comprising:
decrementing the value of a count variable if a previously determined match has a time falling outside of a sliding window having a predetermined temporal length.

9. The computer-implemented method of claim 8 wherein the act of controlling the execution of a host malware protection policy using a value of the count variable includes
1) comparing the value of the count variable with a predetermined threshold value, and
2) executing the host malware protection policy if the value of the count variable exceeds the predetermined threshold value, otherwise, not executing the host malware protection policy.

10. The computer-implemented method of claim 2 wherein the act of controlling the execution of a host malware protection policy further uses an indication that the host system was inactive for at least a second predetermined period of time preceding a determination of the occurrence of a match.

11. The computer-implemented method of claim 10 wherein the indication that the host system was inactive for at least the second predetermined period of time includes determining that the host system had no network activity for the second predetermined period of time preceding a determination of the occurrence of a match.

12. Apparatus for detecting host reboots passively, the apparatus comprising:
a) means for storing a list of one or more host initialization events, each of the one or more host initialization events being associated with a host system;
b) means for receiving packet destination information derived from packets sourced from the host system;
c) means for comparing the received packet destination information with the list of one or more host initialization events to determine whether any matches occur;
d) means for incrementing the value of a count variable if a match is determined to exist, otherwise, maintaining the count variable at its current value; and
e) means for determining whether one or more reboots of the host occurred using the value of the count variable.

13. The apparatus of claim 12 further comprising:
f) means for controlling the execution of a host malware protection policy using a value of the count variable.

14. A computer-implemented method for detecting host reboots passively, the computer-implemented method comprising:
a) accepting information of packet flows for the host system, wherein each of the packet flows corresponds to one or more events, and wherein a plurality of packet flows corresponding to a given one of the one or more events exhibit periodicity;
b) determining, for each of the one or more events, whether or not the event exhibits a phase change using the corresponding plurality of packet flows; and
c) determining whether one or more reboots of the host occurred using the determination of whether or not the event exhibits a phase change.

15. The computer-implemented method of claim 14 further comprising:
d) controlling the execution of a host malware protection policy using the determination of whether or not the event exhibits a phase change.

16. The computer-implemented method of claim 14 further comprising:
accept packets sourced from the host system;
determine packet flows and the one of the one or more events to which the packet flows belong from the accepted packets using at least one of (A) destination IP address of the accepted packets, and (B) destination port number of the accepted packets; and
determining whether any of the determined events exhibits periodicity using time stamps of the accepted packets.

17. The computer-implemented method of claim 14 wherein the act of determining, for each of the one or more events, whether or not the event exhibits a phase change using the corresponding plurality of packet flows includes:
1) determining the period of the event using the corresponding plurality of packet flows,
2) determining whether a time of an instance of the event conforms to the determined period relative to an epoch, and
3) determining that the event exhibits a phase change if the time of the instance of the event does not conform to the determined period relative to an epoch.

18. The computer-implemented method of claim 15 wherein the act of controlling the execution of a host malware protection policy using the determination of whether or not the event exhibits a phase change includes
1) determining a temporal amount of the phase change, and
2) controlling the execution of a host malware protection policy using the determined temporal amount.

19. The computer-implemented method of claim 18 wherein the act of controlling the execution of a host malware protection policy using the determination of whether or not the event exhibits a phase change further includes
1) determining a number of events exhibiting a phase shift, and
2) controlling the execution of a host malware protection policy using the determined number of events exhibiting a phase shift.

20. The computer-implemented method of claim 15 wherein the act of controlling the execution of a host malware protection policy using the determination of whether or not the event exhibits a phase change further includes
1) determining a number of events exhibiting a phase shift, and
2) controlling the execution of a host malware protection policy using the determined number of events exhibiting a phase shift.

21. The computer-implemented method of claim 16 wherein the act of determining whether any of the determined events exhibits periodicity using time stamps of the accepted packets includes:
for each of a plurality of period values T and for each of the events,
determining a modulo T of the time stamps of the events to define T-phase values, and
for any defined T-phase values,
counting a number of times the T-phase value occurred over a sample period to determine a count,
comparing the determined count with a value derived from an expected count for the period T over the sample period, and
determining whether the event is a periodic event using a result of the comparison.

22. Apparatus for detecting host reboots passively, the apparatus comprising:
a) means for accepting information of packet flows for the host system, wherein each of the packet flows corresponds to one or more events, and wherein a plurality of packet flows corresponding to a given one of the one or more events exhibit periodicity;
b) means for determining, for each of the one or more events, whether or not the event exhibits a phase change using the corresponding plurality of packet flows; and
c) means for determining whether one or more reboots of the host occurred using the determination of whether or not the event exhibits a phase change.

23. The apparatus of claim 22 further comprising:
d) means for controlling the execution of a host malware protection policy using the determination of whether or not the event exhibits a phase change.
